(19) United States
(12) Patent Application Publication
(10) Pub. No.: US 2005/0235051 A1
(43) Pub. Date: Oct. 20, 2005

(54) Method of establishing target device settings based on source device settings

(76) Inventors: Timothy Darren Brown, Lexington, KY (US); Chad Eugene McQuillen, Lexington, KY (US); Jeffrey James Watrous, Lexington, KY (US); Bryan Scott Willett, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/827,076

(22) Filed: Apr. 19, 2004

(51) Int. Cl. G06F 15/177; G06F 15/16

(52) U.S. Cl. 709/220; 709/217

(57) ABSTRACT

A method of establishing a plurality of target device settings for at least one target device based on a plurality of source device settings of a source device via a network includes the steps of writing each setting of the plurality of source device settings to the at least one target device, generating an invalid setting indication for each setting not accepted by the at least one target device, querying the at least one target device for setting information based on each the invalid setting indication, and writing, for at least one of each setting not accepted by the at least one target device, a value to the at least one target device, the value corresponding to the setting information.

### BACKGROUND OF THE INVENTION

1. Field of the Invention

The present invention relates to a method of establishing target device settings, and, more particularly, to a method of establishing target device settings based on source device settings.

2. Description of the Related Art

Computer systems and printers are prodigiously employed in the conduct of daily operations in business concerns, both large and small, as well as in governmental operations, schools and universities, hospitals, and other non-profit or charitable enterprises. The computer systems and printers are typically used for many purposes, including the creation of internal documents such as memos, presentations, various records, process and routing sheets, etc., as well as documents intended for external use, i.e., by customers, patients, clients, and such, including brochures, statements, pamphlets, and so on. The printers used by such concerns generally include networked printers, e.g., printers that are connected to local area networks, such as workgroup printers, multifunction products, and/or copy centers.

Each networked printer is typically employed by multiple users, and often, a particular user will use more than one networked printer. These printers are typically distributed throughout one or more networks and many physical locations, and provide user access to various printing or copying capabilities. For example, monochrome printers might be dispersed throughout a business organization for normal use by a small business concern's employees in creating black and white memos, reports, and forms, etc., for daily printing needs, while a centrally located four-color printer may be employed for special use, such as in creating viewgraphs and printed materials for use in product proposal presentations given before the organization's managers.

The use of multiple printers provides a safety net to organization, in that each user can access more than one printer. Thus, if a particular printer were to exhaust its consumable supplies, or experience a paper jam or other problem that renders it temporarily unavailable, a user can simply send a print job to another networked printer.

Because each of the multiple users are able to print documents from any accessible printer, it is desirable that the documents printed by any one printer is similar in appearance to documents printed by any other printer, without the necessity of each user individually adjusting the settings on the particular printer he or she might choose to use. Accordingly, network administrators have typically adjusted the settings on each printer to ensure consistent output between printers. Such settings might include portrait width and height, feed direction, paper size and orientation, and print mode, e.g., color or monochrome. It is desirable that other settings, such as power saver settings, also be consistent throughout an organization.

Typically, a network administrator must manually adjust the settings of each printer. Such a task has proven cumbersome, especially for large organizations that occupy many buildings or areas within buildings. This task is further complicated by the fact that typical organizations do not employ identical printers dispersed throughout their facilities, but rather, employ printers chosen for the needs of the users in the specific areas that the printers are located. For example, in one work area, the printing needs might be relatively small, allowing the use of a low capacity, low cost printer. In another work area, a large volume of printing and/or copying may be routinely performed, and hence, a large capacity unit will be employed. Accordingly, printers of many types and models are used. The settings for the different types and models of printers may include some overlap, i.e., wherein some of the same settings or ranges of settings are the same. Often, however, different machines have non-overlapping settings. For example, one printer may have only one paper tray, while another may have two paper trays, thus requiring the setting of a default paper tray. Accordingly, the task of ensuring consistent output between printers is often a complex one.

In order to ensure consistent output between printers, the inventors have contemplated that the settings of one printer, i.e., a source device, might be employed as a basis for establishing the settings to be used by other printers, i.e., target devices, via a network.

What is needed in the art is a method of establishing target device settings based on the source device settings, via a network.

### SUMMARY OF THE INVENTION

The present invention provides a method of establishing target device settings based on source device settings via a network.

The invention, in one form thereof, relates to a method of establishing a plurality of target device settings for at least one target device based on a plurality of source device settings of a source device via a network. The method includes the steps of writing each setting of the plurality of source device settings to the at least one target device; generating an invalid setting indication for each setting not accepted by the at least one target device; querying the at least one target device for setting information based on each invalid setting indication; and writing, for at least one of each setting not accepted by the at least one target device, a value to the at least one target device, the value corresponding to the setting information.

An advantage of the present invention is that the need to configure each target device individually may be eliminated.

Another advantage is that the success of setting the target device settings may be verified.

Yet another advantage is the ability to establish printer settings for target devices that have different firmware and hardware configurations.

### BRIEF DESCRIPTION OF THE DRAWINGS

The above-mentioned and other features and advantages of this invention, and the manner of attaining them, will become more apparent, and the invention will be better understood by reference to the following description of an embodiment of the invention taken in conjunction with the accompanying drawings, wherein:

FIG. 1 is a diagrammatic depiction of a network computer system embodying the present invention.

FIG. 2 illustrates source device settings that may be used to establish settings in a target device.

FIG. 3 illustrates target device settings for use in a target device.

FIGS. 4A-4F show a flowchart depicting a method according to the present invention.

FIG. 5 depicts a device settings page generated during operation of the present invention.

FIG. 6 depicts an error tracking page constructed during operation of the present invention.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION OF THE INVENTION

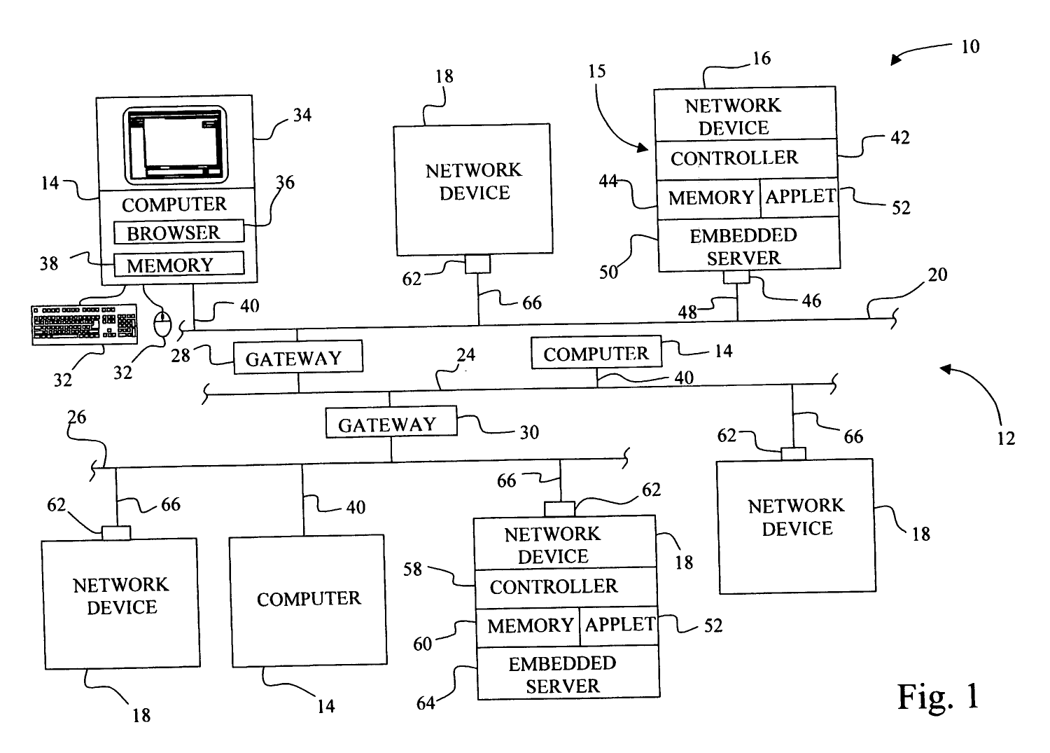

Referring now to the drawings and particularly to FIG. 1, there is shown a network system 10 embodying the present invention. Network system 10 is used to connect a plurality of computers with each other and with other network devices, for example, printers, copiers and fax machines. Network system 10 includes a network 12, at least one computer 14, a source device 16, and at least one target device, such as target device 18. Each of computer 14, source device 16, and target device 18 are connected to network 12, and preferably have unique network identifiers, such as in the form of internet protocol (IP) addresses, domain names, or any other such constructs by which computer 14, source device 16, and target device 18 may be uniquely identified on network 12.

Network 12 is a typical computer network, and may be a local area network (LAN), a wide area network (WAN) such as the Internet, a wireless network, another type of computer network, or any combination of computer networks. As depicted in FIG. 1, network 12 includes a LAN 20, a WAN 24, and a LAN 26. WAN 24 is connected to LAN 20 via gateway 28, and is connected to LAN 26 via gateway 30. Accordingly, LAN 20 is connected to LAN 26 via gateway 28, WAN 24, and gateway 30. Thus, any computer 14 is capable of network connection to any or all of source device 16 and each target device 18.

Computer 14 is a typical computer used in business or home applications, and may be, for example, a personal computer, including memory, one or more of an input device 32, such as a keyboard and/or a mouse, and a display monitor 34. Installed on computer 14 is a web browser, such as browser 36. Computer 14 may further include a processor, input/output (I/O) interfaces, memory 38, such as RAM, ROM, NVRAM, etc., a network adapter, a modem for establishing dial-up connections, and at least one mass data storage device, such as a hard drive, a CD read and/or write unit, and/or a DVD unit. Computer 14 is connected to network 12 via a communication link 40, such as by a cable or wireless connection.

Source device 16 is an apparatus that receives and operates upon information sent to it via network 12, for example, source device 16 is an imaging apparatus. As described herein, source device 16 is an imaging apparatus in the form of a printer used for business or home printing and/or copying applications, and may be, for example, a laser printer, an inkjet printer, or an all-in-one unit that includes the ability to perform printing, scanning, copying, and faxing. Alternatively, it is contemplated that source device 16 may be a stand-alone copying machine, such as a digital copier, a workgroup printer, or any other apparatus capable of communication with computer 14 via network 12, including any personal or commercial machine capable of printing or reproducing printed material.

Source device 16 includes a controller 42, a memory 44, and a communication port 46. Source device 16 is in bi-directional communication with computer 14 via communication port 46 and a communication link 48. Communication link 48 is a typical network connection, used for connecting source device 16 to network 12, and may be a wired or wireless connection.

Controller 42 processes data received by source device 16, and executes instructions to operate source device 16. Controller 42 includes an embedded server 50 that provides source device 16 with bi-directional network communication via network 12.

Memory 44 is any convenient computer readable storage device, for example, a memory such as a RAM, ROM, or EPROM memory. Alternatively, it is contemplated that memory 44 may be a composite memory, and may include any or all of RAM, ROM, or EPROM memory, a flash memory, a disk drive such as a floppy or hard drive, or a CD or DVD unit. Memory 44 may also be partially or completely in the form of an application specific integrated circuit (ASIC). Stored in memory 44 are computer executable instructions that are employed by controller 42 in operating source device 16, and a program 52 in the form of computer executable instructions, e.g., a computer program, that may be employed by controller 42 in conjunction with the operations of embedded server 50. Preferably, program 52 is stored as firmware in source device 16, although program 52 may be stored in any convenient form or manner. Program 52 is employed by the present invention in establishing settings in target devices based on source device settings, as described below. In the present embodiment, it is contemplated that program 52 is a platform independent applet. Alternatively, it is contemplated that program 52 is any application, including a platform dependent application.

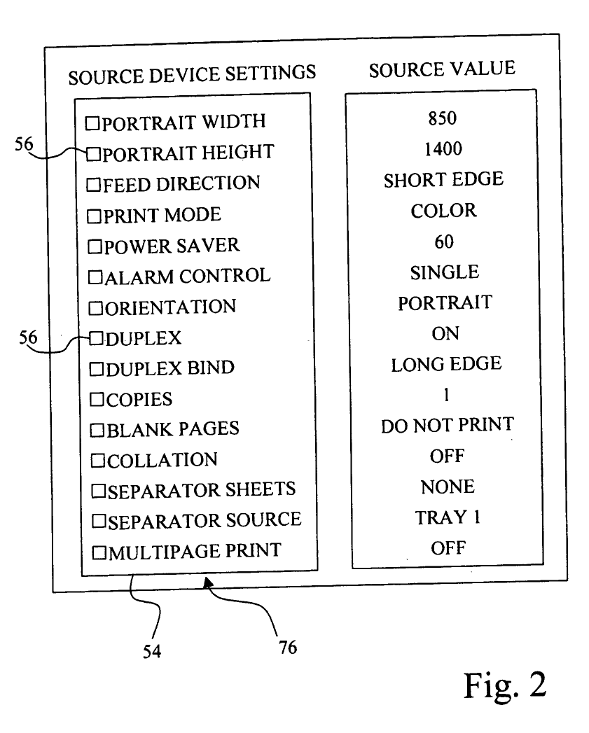

Referring now to FIG. 2, source device 16 incorporates various menu settings, such as a plurality of source device settings 54, stored in memory 44, that are used by source device 16 in rendering output. For example, in the form of a printer, each menu setting of source device settings 54 in source device 16, such as setting 56, controls one of various aspects of printing with source device 16 and/or controls the characteristics of the printed output of source device 16. The values associated with each setting are also depicted in FIG. 2. Each setting 56 of source device settings 54 may be a setting such as portrait width, portrait height, paper feed direction, print mode, e.g., color or monochrome printing, power saver features, paper tray usage, page orientation, e.g., portrait or landscape, etc. It will be understood that many other printer settings may be employed by source device 16 in addition to those depicted in FIG. 2. Each of source device settings 54 may be set or adjusted by accessing a user input panel on source device 16, or may be set remotely, for example, via network 12.

Referring back to FIG. 1, target device 18 is an apparatus that receives and operates upon information sent to it via network 12, for example, such as an imaging apparatus. Target device 18 includes a controller 58, a memory 60, and a communication port 62. Controller 58 includes an embedded server 64 that provides target device 18 with bi-directional network communication with network 12. Memory 60 is similar to memory 44, and hence, the description provided above with regard to memory 44 is equally applicable to memory 60. Stored in memory 60 are computer executable instructions that are employed by controller 58 in operating target device 18, and program 52 employed by controller 58 in conjunction with embedded server 64. Preferably, program 52 is stored as firmware in target device 18, although program 52 may be stored in any convenient manner. Target device 18 may have different firmware and hardware configurations than source device 16.

Target device 18 is in communication with computer 14 via communication port 62 and a communication link 66. Communication link 66 is a typical network connection used for connecting a network device to a network such as network 12, and may be a wired or wireless connection.

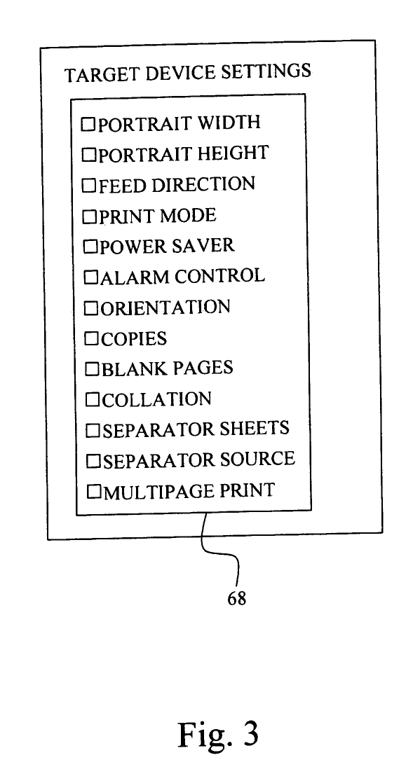

Referring now to FIG. 3, target device 18 also incorporates various menu settings, such as a plurality of target device settings 68 that are used by target device 18 in rendering output. For example, in the form of a printer, each menu setting of target device settings 68 controls one of various aspects of printing with target device 18, and/or controls the characteristics of the printed output of target device 18. Each of target device settings 68 may be a setting such as portrait width, portrait height, paper feed direction, print mode, e.g., color or monochrome printing, power saver features, paper tray usage, page orientation, e.g., portrait or landscape, etc. It will be understood that many other printer settings may be employed by target device 18 in addition to those depicted in FIG. 3. Each of target device settings 68 may be set or adjusted by accessing a user input panel on target device 18, or may be set remotely, for example, via network 12.

In the embodiment described, source device 16 is used as a source of setting values for establishing the settings of other devices. Accordingly, source device settings 54 are obtained from source device 16, and are then transmitted to target devices, such as one or more target device 18, to serve as a basis for establishing target device settings 68. However, it will be understood that source device 16 and any one of target device 18 may be interchangeable, i.e., any network device may be employed as a source device from which to extract settings that will serve as the basis for establishing settings in other network devices.

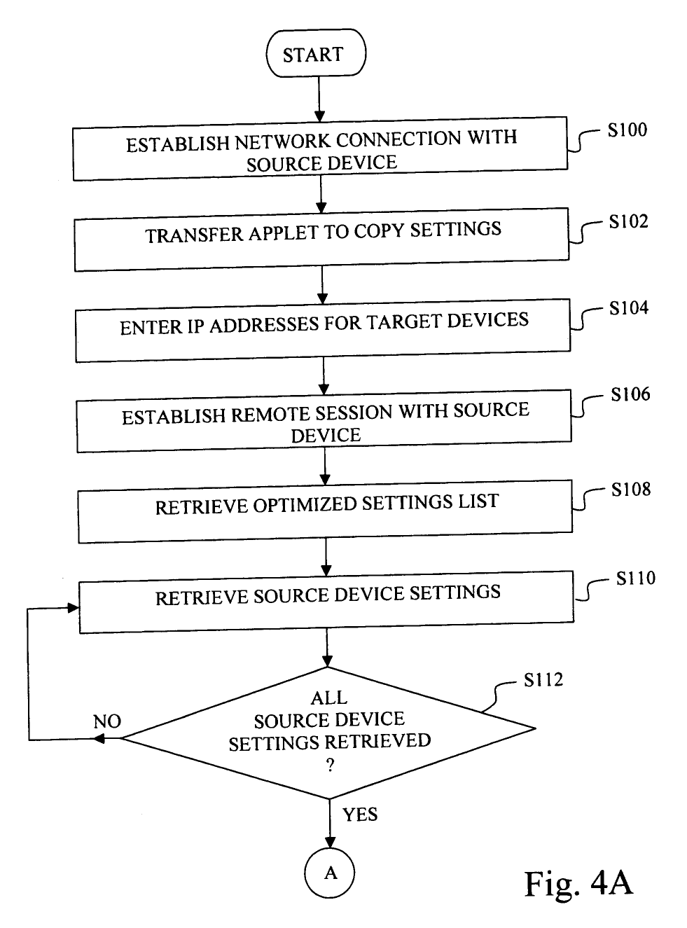

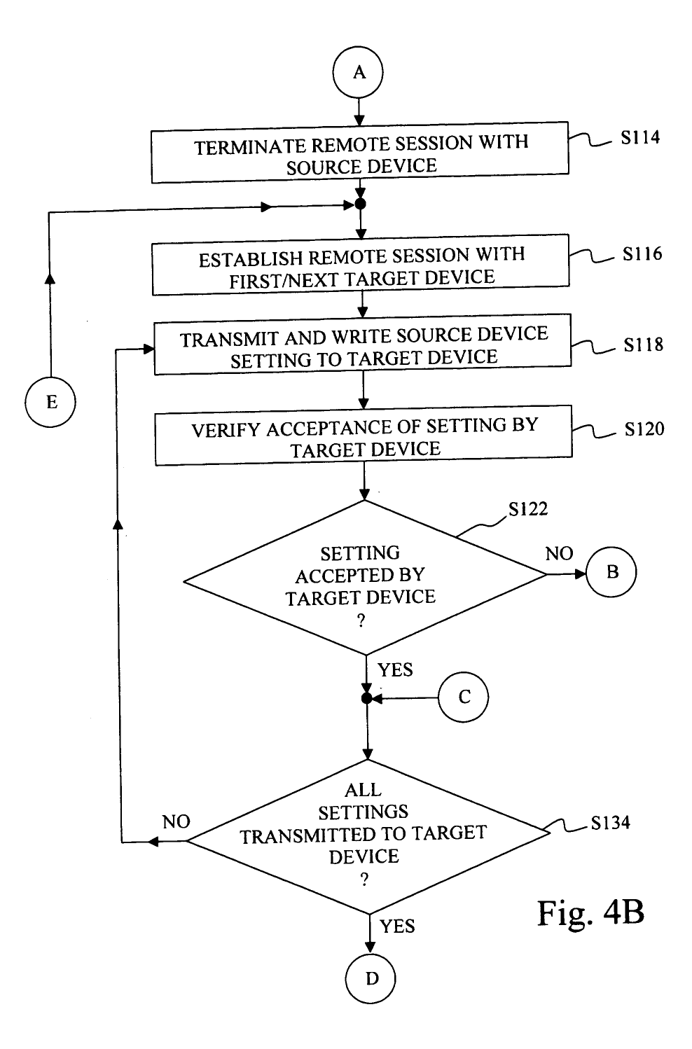

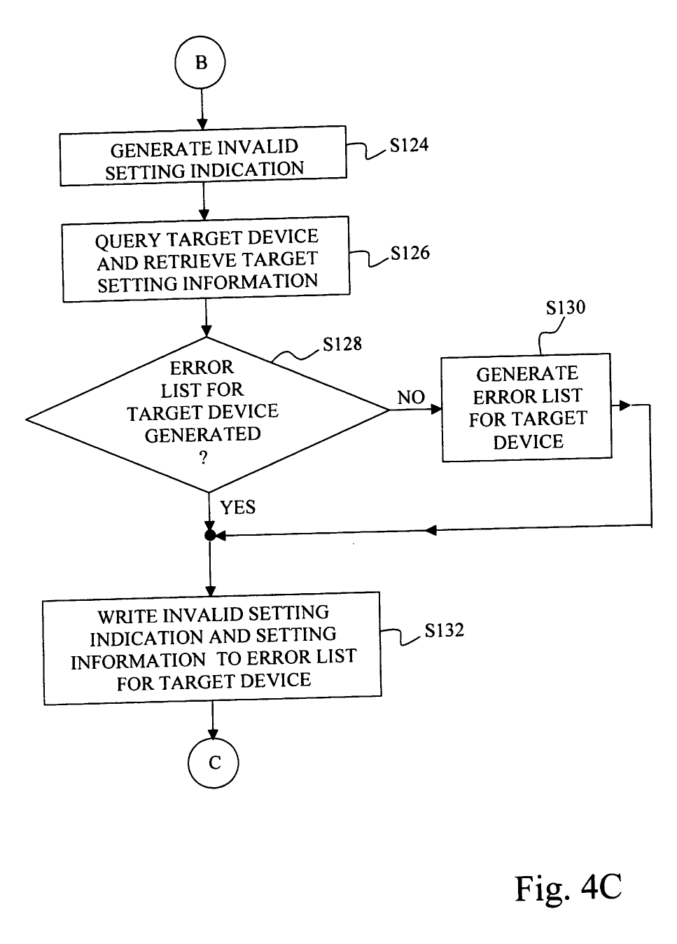

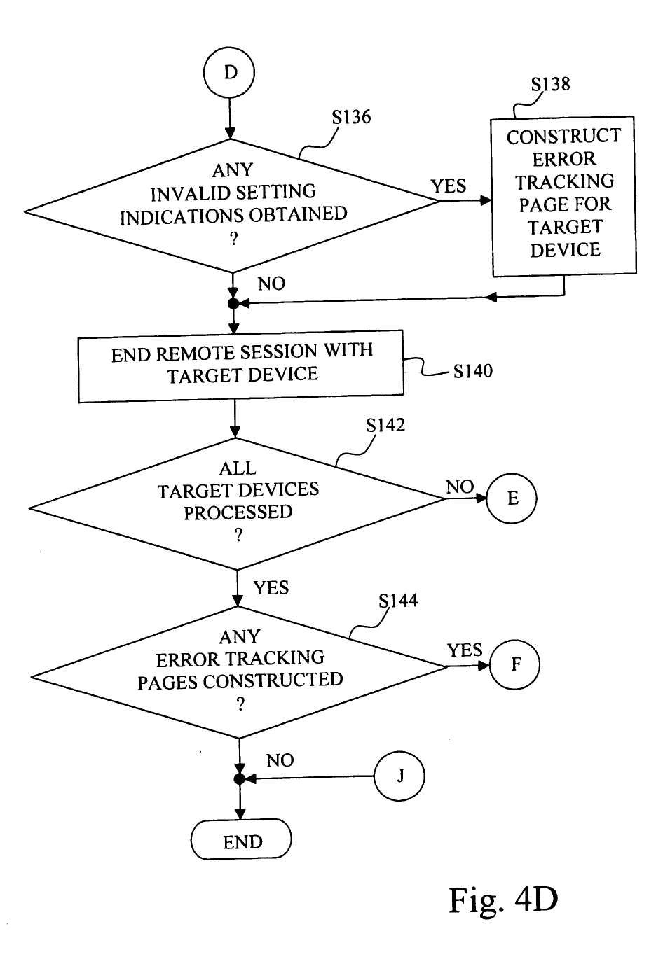

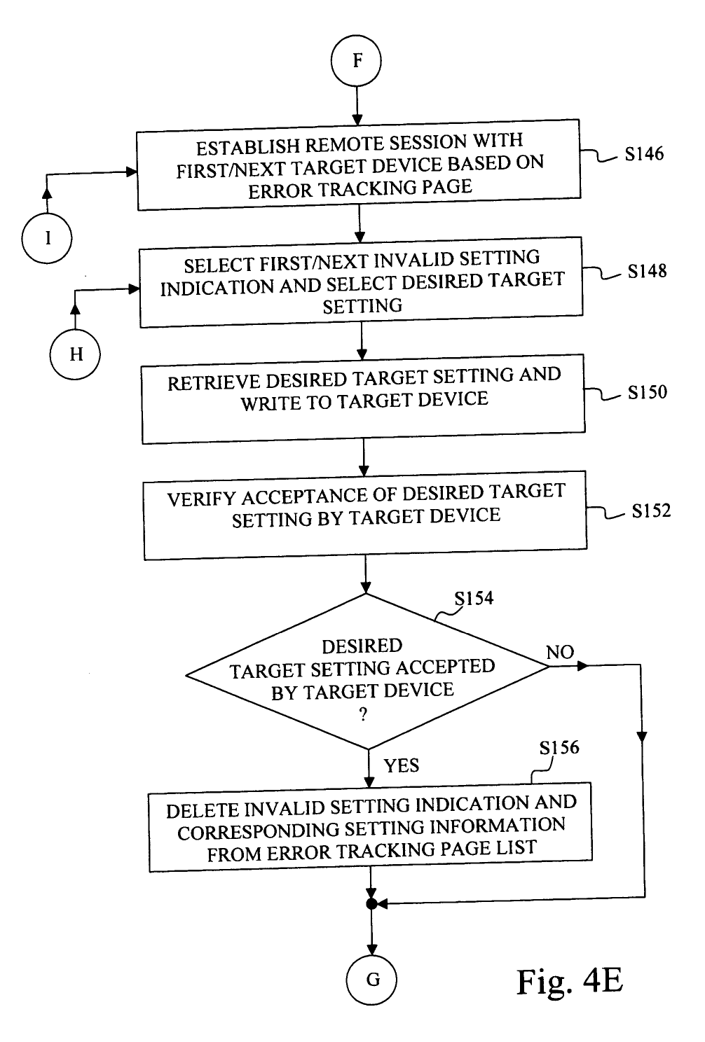

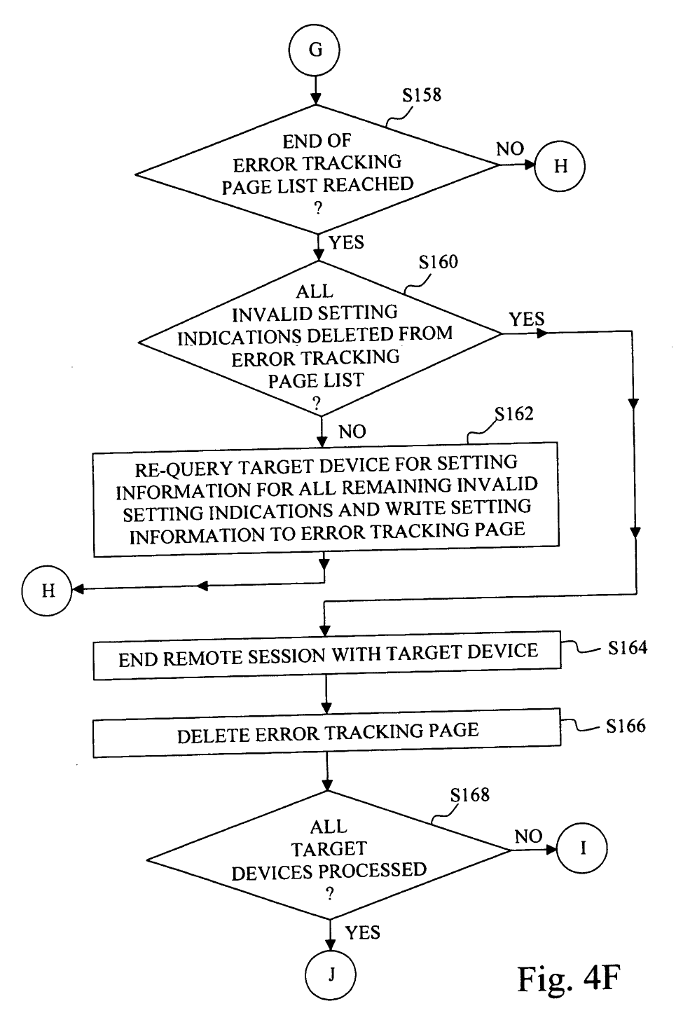

Referring now to FIGS. 4A-4F, and more particularly, to FIG. 4A, there is generally depicted a method for establishing a plurality of target device settings 68 for at least one target device, such as target device 18, based on a plurality of source device settings 54, via network 12.

At a step S100, a network connection is established between computer 14 and source device 16. Step S100 may be performed in one of many ways known in the art. In the present embodiment, a network administrator establishes a link to embedded server 50 using the IP address of source device 16. For example, by entering a source device IP address 69 into the address line of browser 36, e.g., http://192.168.1.100, where “192.168.1.100” is a source device IP address 69 of source device 16, a link is established between computer 14 and source device 16. Once the link is established, embedded server 50 of source device 16 transmits an introduction HTML (hypertext markup language) page, i.e., a web page, to computer 14, which is displayed on display monitor 34 by browser 36. The source device introduction HTML page includes identifying information pertaining to the source device, and includes a “Copy Printer Settings” button, which is an HTML link to program 52. Program 52 is used for copying source device settings 54 to target device 18.

At step S102, program 52 is transmitted to computer 14. Embedded server 50 of source device 16 transmits program 52 to computer 14 via network 12 in response to the network administrator engaging the “Copy Printer Settings” button in the source device introduction HTML page displayed by browser 36, for example using input device 32.

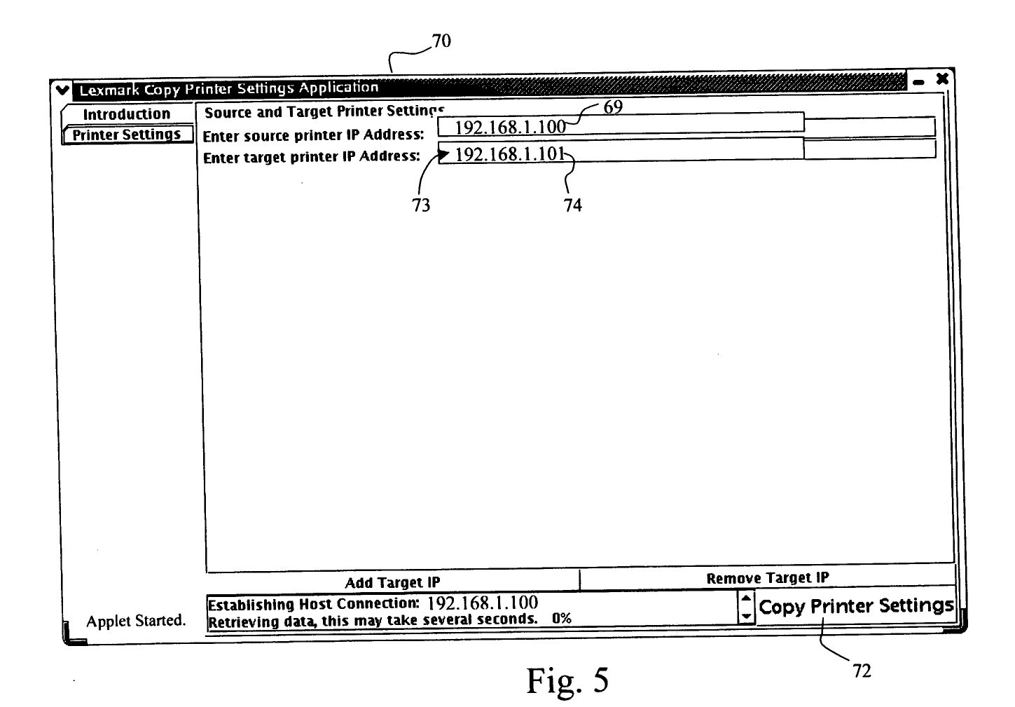

Referring now to FIG. 5, once program 52 is transmitted to computer 14, program 52 is executed in browser 36, and launches a device settings page 70, for example, in the form of a graphical user interface (GUI) for receiving user input, which is displayed on display monitor 34 by browser 36. As illustrated, device settings page 70 lists the IP address of source device 16, and includes buttons to add or remove target device IP addresses. Device settings page 70 also includes a copy printer settings button 72, which is used to establish a remote session with source device 16. Device settings page 70 provides a user, such as the network administrator, with an interface for entering the IP addresses for the desired target devices.

Referring back to FIG. 4A, at step S104, the IP address of each target device 18 chosen by the network administrator is entered into device settings page 70. For example, as depicted in FIG. 5, target device IP address 74, 192.168.1.101, has been added to device settings page 70. Errors made during the entry of IP addresses can be corrected using the add target IP address button and/or the remove target IP address button provided on device settings page 70.

At step S106, a remote session with source device 16 is established by engaging copy printer settings button 72 in device settings page 70, for example, using input device 32. Once copy printer settings button 72 is engaged, program 52 establishes a network connection with a specific port on source device 16, such as a port 5000 (not shown).

At step S108, an optimized list of source settings in the form of optimized settings list 76 is retrieved from a location 15. In the present embodiment it is contemplated that location 15 is in the form of source device 16. Alternatively, it is contemplated that location 15 may be another location, e.g., a website of the manufacturer of source device 16 and/or target device 18 or another website accessed via network 12, a computer disk or file, or any convenient storage device, memory, or system. Optimized settings list 76 is based on a list of source device settings optimized based on a dependency of any given setting upon another setting, and is used to minimize problems due to setting dependencies that might occur when the settings are copied to target device 18. For example, an MP Configuration setting (Multi-Purpose Feeder Configuration setting) affects Paper Size and Paper Type settings, and therefore, should be copied to target device 18 before copying the Paper Size and Paper Type settings.

At step S110, source device settings 54 are retrieved from location 15 to computer 14. Source device settings 54 include setting type, setting value, and menu text for each menu setting of source device 16. The setting type pertains to whether the setting value is Boolean, i.e., a setting that is simply turned on or off, a text value, or is one of a range of possible values, that may be used for the particular setting.

At step S112, a determination is made as to whether all of source device settings 54 have been retrieved. If not, step S110 is repeated until all of source device settings 54 have been retrieved. Once all of source device settings 54 have been retrieved, the process flow of the present invention moves to step S114.

Referring now to FIG. 4B, at step S114, the remote session with source device 16 is ended by program 52 automatically terminating the network connection with source device 16.

As set forth below, computer 14 has access to each target device 18 via network 12, and program 52 executes on computer 14 to perform the steps of writing each setting to each selected target device 18, generating invalid setting indications for each setting not accepted by a target device 18, querying each target device for setting information based on each invalid setting indication, and writing, for at least one of each setting not accepted by a target device 18, a value to the target device 18 that corresponds to the setting information.

At step S116, program 52 establishes a remote session with a target device based on the target device IP addresses provided in step S104. For example, program 52 establishes a remote session with target device 18 based on target device IP address 74. If this is the first occurrence of step S116 in an execution of the method of the present embodiment, the target IP address is the first IP address listed in step S104. Alternatively, it is contemplated that the first target device IP address may be the first in a sorted list of those target device IP addresses entered in step S104. If this is not the first occurrence of step S116, a remoter session with the next target device is established using the next target device IP address from step S104.

At step S118, program 52 transmits each of setting from source device settings 54 to target device 18 and writes a setting to target device 18 according to optimized settings list 76.

At step S120, program 52 verifies transmitting the setting and verifies whether target device 18 has accepted the setting written in step S118. Verification is performed by target device 18 sending an automatic reply to computer 14 in response to the write attempt of step S118, which indicates whether or not the write attempt was successful. The failure of target device 18 to send a reply indicates that the setting was not properly transmitted to target device 18. Alternatively, however, program 52 may query target device 18 to determine whether the write attempt was successful.

At step S122, if program 52 determines that the write attempt of step S118 was not successful, e.g., target device 18 did not accept the setting, the process flow of the present embodiment proceeds to step S124. Otherwise, the process flow proceeds to step S134. The inventors foresaw that target device 18 may have different firmware and/or hardware configurations than source device 16, and discovered a way to accommodate such a target device 18, which by virtue of firmware and/or hardware differences will not accept certain source device settings. As set forth below, invalid setting indications are generated and acted upon by the present invention in order to accommodate any firmware and/or hardware differences of target device 18.

Referring now to FIG. 4C, at step S124, an invalid setting indication, such as invalid setting indication 78, is generated for each setting not accepted by target device 18. The generated invalid setting indication is essentially an indication that a particular setting was not accepted by target device 18, and hence, is invalid for the particular target device 18.

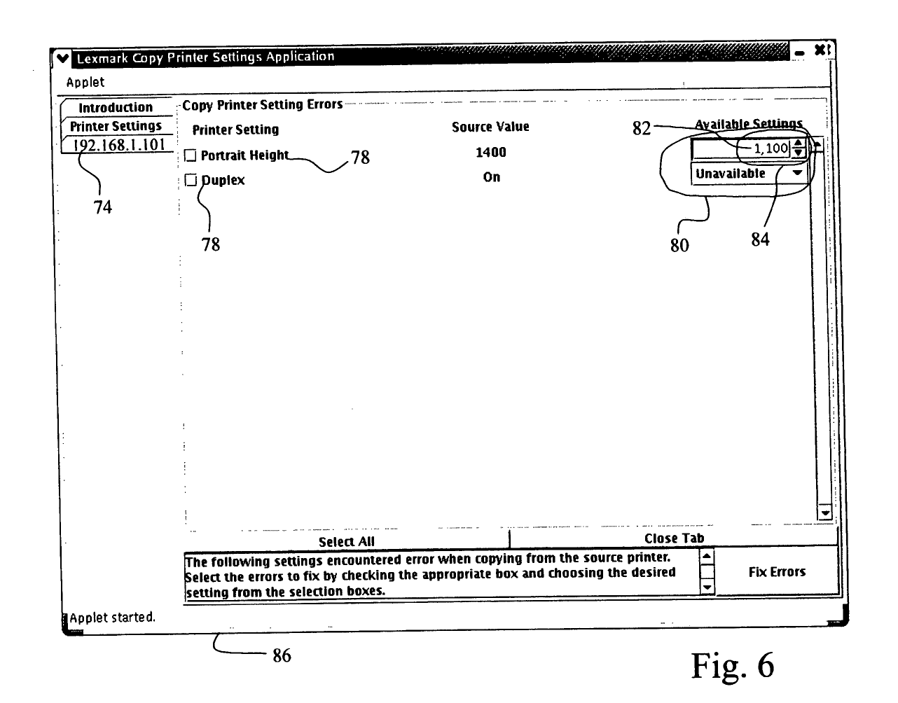

At step S126, program 52 queries target device 18 for setting information based on each invalid setting indication, e.g., setting information 80 corresponding to each invalid setting indication 78, and retrieves the setting information from target device 18. The setting information pertains to the allowable settings or range of settings that may be employed by the particular target device 18 corresponding to the source device setting that was sought to be written by program 52 in step S118. The setting information includes the current setting value employed by target device 18, i.e., that value employed by target device 18 before initiating the present embodiment method. For example, with reference to FIG. 6, setting information 80 includes current target device setting 82 of 1,100 for portrait height. If a particular source setting is not available for use with target device 18, current target device setting 82 may be a text indication in the form of “Unavailable” or “N/A.” Setting information 80 also includes the setting type, menu text for each menu setting of source device 18, and available settings 84 for target device 18. Available settings are those settings that may be written to and accepted by target device 18, and includes valid setting values or ranges of values. For example, in FIG. 5, the “up” and “down” arrows of available settings 84 may be used to select values other than the current value of 1,100 for the portrait height setting. If a particular source setting is not available for use with target device 18, available settings 84 may indicate “Unavailable” or “N/A.”

At step S128, a determination is made as to whether an error list was previously constructed for the particular target device 18. If not, the process flow of the present embodiment proceeds to step S130. If so, the process flow proceeds to step S132.

At step S130, an error list is constructed for the particular target device 18 for which the write attempts have been made in step S118. Such an error list is constructed for each target device 18 for which at least one invalid setting indication was generated. The error list is a list of each of the invalid setting indications for a particular target device 18, such as invalid setting indication 78, corresponding to the source device setting that was not accepted, along with the setting information, such as setting information 80. The error list is used in the present embodiment for completing the establishment of target device settings 68 for the particular target device 18, as discussed below.

At step S132, the invalid setting indication and the setting information, for example, each invalid setting indication 78 and setting information 80, are written to the error list.

Referring again to FIG. 4B, at step S134, program 52 determines whether all of source device settings 54 were transmitted to target device 18. If not, the process flow of the present embodiment returns to step S118 to transmit the next setting to the particular target device 18. If all source device settings 54 have been transmitted to target device 18, process flow proceeds to step S134.

Referring now to FIG. 4D, at step S136, a determination is made as to whether any invalid setting indications were obtained for the particular target device 18. If so, the process flow of the present embodiment proceeds to step S138. Otherwise, the process flow proceeds to step S140.

At step S138, an error tracking page is constructed for the particular target device 18, for example, with reference to FIG. 6, an error tracking page such as error tracking page 86. In the case of multiple target devices, a separate error tracking page is constructed for each target device that encountered errors, i.e., an error tracking page corresponds to each target device 18 from which an invalid setting indication was obtained. For example, error tracking page 86 corresponds to a unique network identifier 73, such as target device IP address 74 of target device 18. Each error tracking page 86 lists each invalid setting indication for each corresponding target device 18. It will be understood that, alternatively, unique network identifier 73 may be in the form of a domain name or any other such construct by which target device 18 may be uniquely identified via network 12.

Error tracking page 86 provides an interface to display settings that were not accepted by target device 18, and to allow the user, e.g., the network administrator, to correct these errors. The invalid setting indications typically occur when a menu setting available on a source device is not available on the target device, or the value used for the setting in the source device is not available on the target device, for example, as might occur if the source device and target device are different devices, different device models, or employ different firmware, such as different firmware configurations or different revisions of the same firmware configuration, and/or different hardware configurations.

For example, if the source device was a printer having two input paper trays, source device settings 54 might include the option to select tray 2 as the paper source, as well as the option to set up the tray 2 paper size and type. However, if the target device is a printer having only one input paper tray, such options will not be available, and an invalid setting indication will be obtained if these settings are written to the target device.

At step S140, the remote session with the particular target device 18 is ended by terminating the network connection with the target device 18.

At step S142, program 52 determines whether all of target devices with target device IP addresses entered in step S104 have been processed. If not, the present embodiment method returns to step S116 to establish a remote setting with the next target device 18. If all target devices have been processed, the method proceeds to step S144.

At step S144, a determination is made as to whether any error tracking pages were constructed for any target device 18. If not, then target device settings 68 for all target devices have been established based on the source device settings 54 of source device 16, and the method of the present embodiment ends.

If any error tracking pages were constructed for one or more target device 18, then additional measures are taken in order to complete target device settings 68. Accordingly, by virtue of steps S146 to S168, program 52 writes, for each setting not accepted by at least one target device, a value to the target device corresponding to setting information 80, i.e., corresponding to the settings that were not accepted.

Referring now to FIG. 4E, at step S146, program 52 establishes a remote session with a target device based on the unique network identifier 73 provided in an error tracking page, such as error tracking page 86, which provides the target device IP address. Thus, for example, program 52 establishes a remote session with target device 18 based on target device IP address 74 of 192.168.1.101. If this is the first occurrence of step S146 in an execution of the method of the present embodiment, the target IP address is that shown on the first error tracking page that was constructed. Otherwise, the IP address pertains to the target device associated with a subsequent error tracking page 86, if any.

At step S148, the first or next invalid setting indication 78 is selected from error tracking page 86, and a desired target setting is selected by the network administrator from available settings 84.

At step S150, program 52 retrieves a desired target setting from available settings 84, and writes the desired target setting to target device 18.

At step S152, program 52 verifies transmitting the desired target setting and verifies whether target device 18 has accepted the desired target setting written in step S150. Verification is performed by target device 18 sending an automatic reply to computer 14 in response to the write attempt of step S150, which indicates whether or not the write attempt was successful. The failure of target device 18 to send a reply indicates that the setting was not properly transmitted to target device 18. Alternatively, however, program 52 may query target device 18 to determine whether the write attempt was successful.

At step S154, if it is determined that the write attempt of step S150 was not successful, i.e., that target device 18 did not accept the desired target setting, the process flow of the present embodiment proceeds to step S158. If a step S150 write attempt was unsuccessful, e.g., was not accepted by target device 18, the corresponding desired target setting is addressed at step S162. Otherwise, the process flow proceeds to step S156.

At step S156, program 52 deletes the invalid setting indication 78 accepted by target device 18 and the corresponding setting information 80 from the error tracking page 86 corresponding to invalid setting indication 78. Note that by virtue of the process flow of the present embodiment method that step S156 is performed only for those desired target settings that were accepted by the particular target device 18.

Referring now to FIG. 4F, at step S158, if program 52 has completed an initial pass through the listing of each invalid setting indication 78 in error tracking page 86, the process flow of the present embodiment proceeds to step S160. Otherwise, the process flow proceeds back to step S148 to select the next invalid setting indication 78. Note that if any desired target settings were not accepted by target device 18, each corresponding invalid setting indication 78 and setting information 80 remain on error tracking page 86.

At step S160 if program 52 determines that all invalid setting indications were deleted from the list of error tracking page 86, the process flow of the present embodiment method proceeds to step S164. Otherwise, the process flow proceeds to step S162.

At step S162, program 52 re-queries target device 18 for setting information 80 for each remaining invalid setting indication 78 on error tracking page 86, and writes setting information 80 to error tracking page 86. The process flow of the present embodiment method then proceeds back to step S148 so that desired target settings may be selected and written to target device 18 via steps S148-S162.

At step S164, the remote session with the particular target device 18 is ended by terminating the network connection with the particular target device 18.

At step S166, error tracking page 86 for the particular target device 18 is deleted. At this point no invalid setting indications remain on error tracking page 86 for the particular target device 18.

At step S168, if program 52 determines that all target devices were processed to incorporate desired target settings, i.e., that each error tracking page 86 has been processed and deleted, the process flow of the present embodiment method ends. Otherwise, the process flow proceeds to step S146 to begin processing the next target device 18 using the corresponding error tracking page 86.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of establishing a plurality of target device settings for at least one target device based on a plurality of source device settings of a source device via a network, comprising the steps of:
writing each setting of said plurality of source device settings to said at least one target device;
generating an invalid setting indication for each setting not accepted by said at least one target device;
querying said at least one target device for setting information based on each said invalid setting indication; and
writing, for at least one of said each setting not accepted by said at least one target device, a value to said at least one target device, said value corresponding to said setting information.

2. The method of claim 1, further comprising the step of retrieving said plurality of source device settings from a location prior to said writing said each setting.

3. The method of claim 1, further comprising the step of retrieving an optimized list of source device settings from a location, wherein said writing said each setting includes writing said each setting according to said optimized list of source device settings.

4. The method of claim 3, wherein said optimized list of source device settings is based on a dependency of one of said each setting upon another of said each setting.

5. The method of claim 1, further comprising the step of verifying an acceptance of said each setting by said at least one target device prior to said generating said invalid setting indication.

6. The method of claim 1, wherein said source device transmits a program to a computer via said network, said computer having access to said at least one target device via said network, said program executing on said computer to perform said steps of said writing said each setting, said generating said invalid setting indication, said querying said at least one target device, and said writing said value.

7. The method of claim 1, further comprising the step of constructing at least one error tracking page listing each said invalid setting indication.

8. The method of claim 7, wherein said at least one error tracking page corresponds to said at least one target device.

9. The method of claim 7, wherein said at least one error tracking page corresponds to a unique network identifier of said at least one target device.

10. The method of claim 1, wherein said setting information includes a current target device setting.

11. The method of claim 1, wherein said setting information includes available settings for said at least one target device.

12. A computer readable storage device storing a set of computer executable instructions for implementing a method of establishing a plurality of target device settings for at least one target device based on a plurality of source device settings of a source device via a network, said method comprising the steps of:
writing each setting of said plurality of source device settings to said at least one target device;
generating an invalid setting indication for each setting not accepted by said at least one target device;
querying said at least one target device for setting information based on each said invalid setting indication; and
writing, for at least one of said each setting not accepted by said at least one target device, a value to said at least one target device, said value corresponding to said setting information.

13. The computer readable storage device of claim 12, further comprising the step of retrieving said plurality of source device settings from a location prior to said writing said each setting.

14. The computer readable storage device of claim 12, further comprising the step of retrieving an optimized list of source device settings from a location, wherein said writing said each setting includes writing said each setting according to said optimized list of source device settings.

15. The computer readable storage device of claim 14, wherein said optimized list of source device settings is based on a dependency of one of said each setting upon another of said each setting.

16. The computer readable storage device of claim 12, further comprising the step of verifying an acceptance of said each setting by said at least one target device prior to said generating said invalid setting indication.

17. The computer readable storage device of claim 12, wherein said source device transmits a program to a computer via said network, said computer having access to said at least one target device via said network, said program executing on said computer to perform said steps of said writing said each setting, said generating said invalid setting indication, said querying said at least one target device, and said writing said value.

18. The computer readable storage device of claim 12, further comprising the step of constructing at least one error tracking page listing each said invalid setting indication.

19. The computer readable storage device of claim 18, wherein said at least one error tracking page corresponds to said at least one target device.

20. The computer readable storage device of claim 18, wherein said at least one error tracking page corresponds to a unique network identifier of said at least one target device.

21. The computer readable storage device of claim 12, wherein said setting information includes a current target device setting.

22. The computer readable storage device of claim 12, wherein said setting information includes available settings for said at least one target device.

23. An imaging apparatus having a controller configured to execute computer executable instructions for implementing a method of establishing a plurality of target device settings for at least one target device based on a plurality of source device settings of a source device via a network, said method comprising the steps of:
writing each setting of said plurality of source device settings to said at least one target device;
generating an invalid setting indication for each setting not accepted by said at least one target device;
querying said at least one target device for setting information based on each said invalid setting indication; and
writing, for at least one of said each setting not accepted by said at least one target device, a value to said at least one target device, said value corresponding to said setting information.

24. The imaging apparatus of claim 23, further comprising the step of retrieving said plurality of source device settings from a location prior to said writing said each setting.

25. The imaging apparatus of claim 23, further comprising the step of retrieving an optimized list of source device settings from a location, wherein said writing said each setting includes writing said each setting according to said optimized list of source device settings.

26. The imaging apparatus of claim 25, wherein said optimized list of source device settings is based on a dependency of one of said each setting upon another of said each setting.

27. The imaging apparatus of claim 23, further comprising the step of verifying an acceptance of said each setting by said at least one target device prior to said generating said invalid setting indication.

28. The imaging apparatus of claim 23, wherein said source device transmits a program to a computer via said network, said computer having access to said at least one target device via said network, said program executing on said computer to perform said steps of said writing said each setting, said generating said invalid setting indication, said querying said at least one target device, and said writing said value.

29. The imaging apparatus of claim 23, further comprising the step of constructing at least one error tracking page listing each said invalid setting indication.

30. The imaging apparatus of claim 29, wherein said at least one error tracking page corresponds to said at least one target device.

31. The imaging apparatus of claim 29, wherein said at least one error tracking page corresponds to a unique network identifier of said at least one target device.

32. The imaging apparatus of claim 23, wherein said setting information includes a current target device setting.

33. The imaging apparatus of claim 23, wherein said setting information includes available settings for said at least one target device.
